(19) United States
(12) Patent Application Publication
(10) Pub. No.: US 2025/0391252 A1
(43) Pub. Date: Dec. 25, 2025

(54) 2Last: An Upgraded Charitable Lottery

(71) Applicant: Gideon Samid, Rockville, MD (US)

(72) Inventor: Gideon Samid, Rockville, MD (US)

(21) Appl. No.: 18/752,303

(22) Filed: Jun. 24, 2024

(51) Int. Cl. G07F 17/32

(52) U.S. Cl. CPC G07F 17/329; G07F 17/3244; G07F 17/3295

(57) ABSTRACT

This invention extends the private money specified in the continued applications to build an upgraded lottery where the outcome determinator is a mix between randomness and human reasoning; set up in a way that makes this upgraded lottery playable by all, without discrimination against the less learned and less knowledgeable. With its global outreach, and global digital money, this invented lottery is prospectively far reaching.

Continuation in Part Of U.S. patent application Ser. No. 17/862,285 filed Jul. 11, 2022 which claims benefit of Provisional Application 63/276,662 filed Nov. 8, 2021.
This application is also a continuation in parts of application Ser. No. 17/207,694. This application is also a continuation in part of application Ser. No. 15/582,784 filed May 1, 2017. This application is also a continuation in part of U.S. patent application Ser. No. 14/352,994, filed on Apr. 18, 2014 as national stage application of PCT/US2012/061331, filed on Oct. 22, 2012, which claims the benefit of U.S. Provisional Patent Application Ser. No. 61/627,977, filed Oct. 22, 2011 and U.S. Provisional Patent Application No. 61/688,788, filed May 22, 2012.
This application is also a continuation-in-part of U.S. patent application Ser. No. 15/337,203, filed Oct. 28, 2016, which is a continuation of U.S. patent application Ser. No. 14/737,924, filed Jun. 12, 2015, which is a continuation of U.S. patent application Ser. No. 13/529,399, filed Jun. 21, 2012, which is a continuation of U.S. patent application Ser. No. 12/081,412, filed Apr. 15, 2008, now U.S. Pat. No. 8,229,859, which claims the benefit of U.S. Provisional Patent Application Ser. No. 60/960,672, filed Oct. 9, 2007 and U.S. Provisional Patent Application No. 60/907,869, filed Apr. 19, 2007,
This application claims the benefit of U.S. Provisional Applications 63/641,398 filed May 1, 2024 and U.S. Provisional Application 63/663,214 filed on 2024 Jun. 24
all of which are incorporated by reference in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Global private cyber money creates new opportunities for charitable lotteries, raising global money for worthy causes. Also, cyberspace offers communication opportunities among lottery participants which suggests a new class of lotteries where the classic determinator randomness is complemented with human reasoning. Yet, unlike quiz based games and knowledge demanding participation, the new reality in cyberspace allows for free flow of money, and ideas in ways that do not discriminate against the less learned and less trained. Lotteries are open to all, entertainment to all, and under these terms there is room for upgrading, as this invention proposes.

### BRIEF SUMMARY OF THE INVENTION

In a regular lottery randomness determines the outcome, no room for human reasoning; presenting 2Last, a lottery process where randomness shares control with the human mind, creating a challenging, educational, and more entertaining tool to raise money for worthy causes. The monetary transactions of this upgraded lottery are based on the private digital coins described in the continued application Ser. No. 17/537,381. 2Last is a highly flexible game where players are challenged to pay attention to each other, build a collaboration-competition balance between acquaintances and between strangers, and are challenged to study a particular field of knowledge featured in the game. Unlimited number of participants, (two and up), local or remote, rich variety for allocating prizes and monetary rewards on top of a sizeable charitable contribution; requires little overhead, run by a game master, audience oriented, rich with implementation options. Can be implemented with prime purpose being, training in communication and collaboration, education and entertainment. 2Last attracts special interest because of its utter simplicity, and its structure: to win, one needs to belong to a minority, but if members of the majority rush to the winning minority—they flip the minority into the losing majority; hence the winning moves, per each round of the game can only be probabilistically reasoned. Unlike a regular lottery 2Last participant gain advantage through correct anticipation of what the others would do, and through collaboration—that's the key challenge!

### BRIEF EXPLANATION OF DRAWINGS

FIG. 1 Private Game.

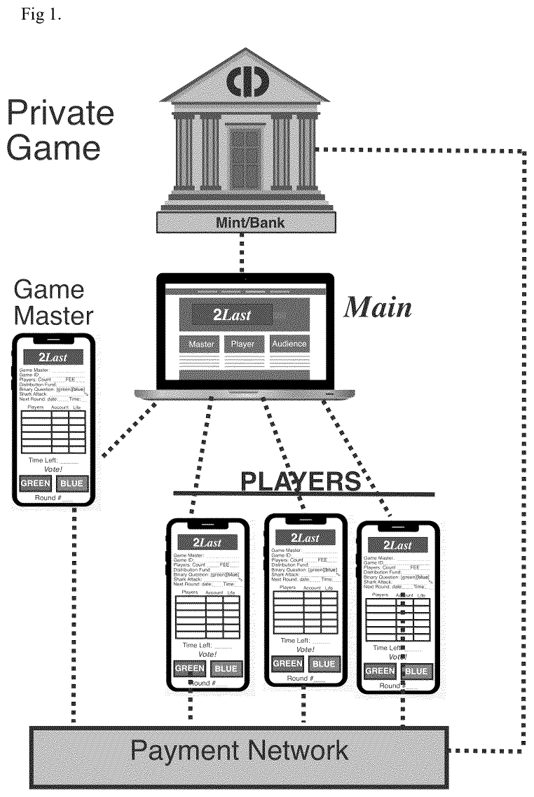

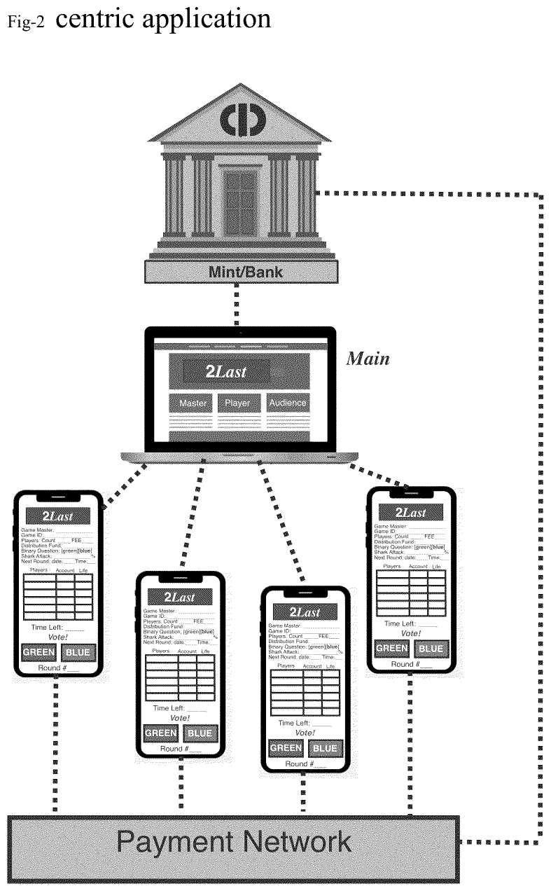

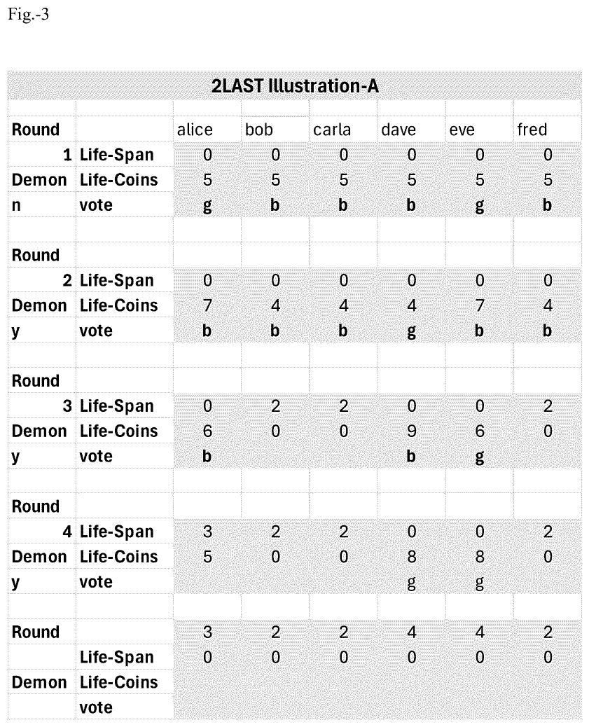

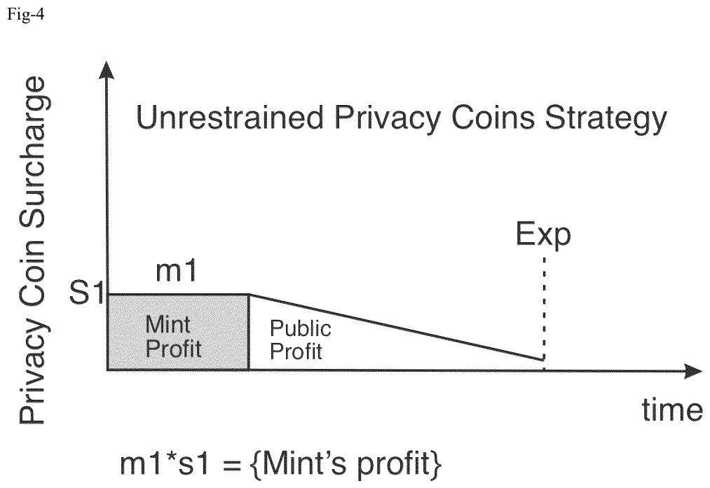

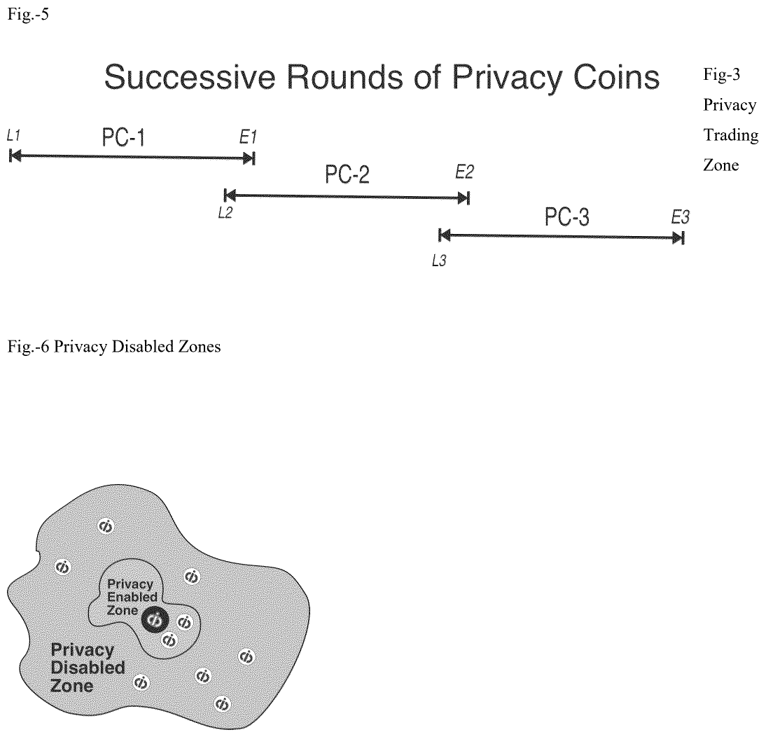

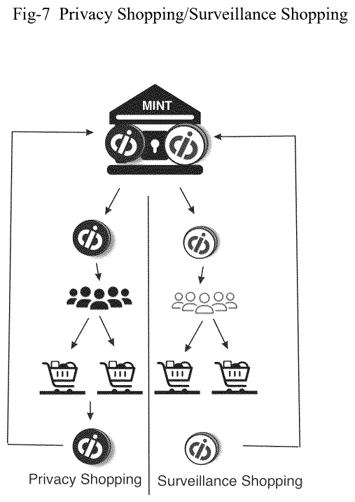

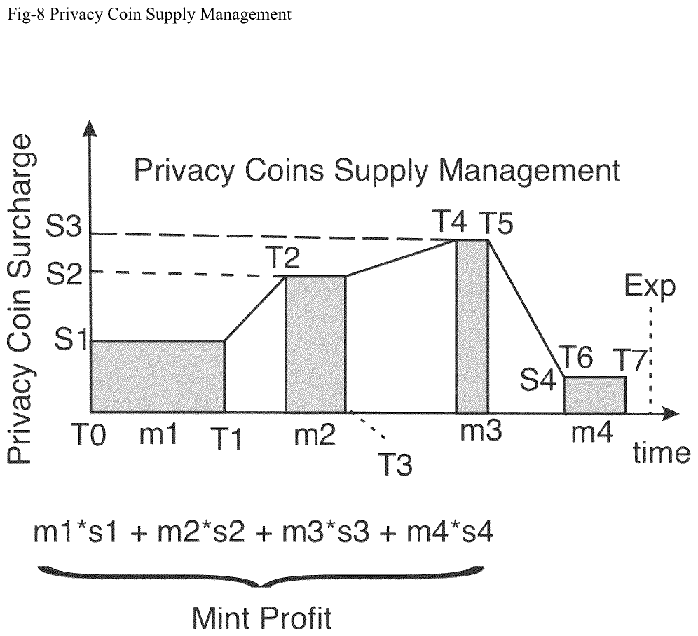

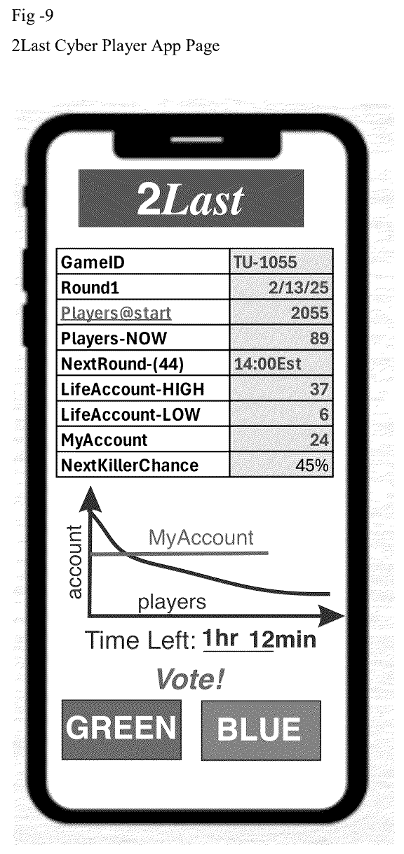

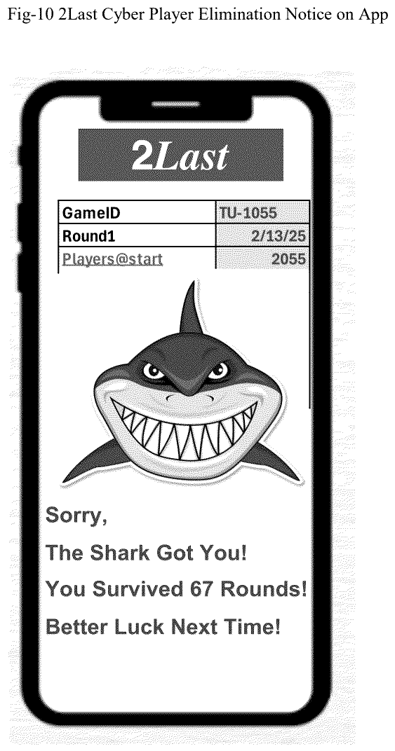

This figure shows the layout for private 2Last games, played through the main website of the 2Last game. The website is connected to a financial institution with the option to mint digital coins. This option allows for players to play anonymously. The regulatory authority in charge may agree to let winner walk away with untrained (non laundered) digital coins if the cash register is first serving a recognized charitable cause, at a rate of say 50%. This will draw shady money to the clear. Alas, 2Last can be played with classical money much the same. The figures shows on the left side the game master who registers as such at the 2Last website. There is cost involved typically. The registrating game master decides on the parameters of the game, the binary question, the initial account levels, the killer probability per round, etc. The 2Last main website is set up to prepare a game per the game master request. Then the game master of the 2Last entrepreneur are going out to register players. In a private format as described here it is usually the game master who is doing the recruiting. All parties are connected through the prevailing payment networks, to pay participation fee and to be rewarded with the winning price. All players and the game master use a dedicated phone or computer application that manages the connections with the main 2Last website. Different views on the application will show the players everything they need to see in order to make the next vote (select between the two binary options).

FIG. 2 Centric Application

This figure shows the main 2Last website. It is announcing several games in parallel, each with specific terms as to timing rules, killer probability, the nature of the binary question etc. It advertises so that would be players are registrating from all around the world and are placed in the game they choose. Each player sees a unique id of all other players, but may not know who is behind that ID. Games with sophisticated cross competitors communications will foster cooperation between two or more individuals who never met and know nothing about each other—this is a social cohesion game. They play by the rules set forth the 2Last website.

FIG. 3: 2Last Illustration-A

This figures show a 2Last sequence with six competitors, Alice, Bob, Clara, Dave, Eve and Fred. The figures show the evolution of the lifespan and life coins for all competitors as the rounds proceeds. Round 1 is taken place over the life-span list all 0, 0 . . . 0 indicating that initially all the competitors are live. It is been decided that all players receive a starting life coin account of 5 coins, so indicated.

Round 1 of questions to select between green and blue is shown in the upper set marked as round 1. 4 vote blue and 2 vote green, so the green get 2 each since the blue give one coin each. The demon was not activated in round 1, so round 2 proceeds.

Round 2 also starts with life-span marked as “0” namely the competitors are all alive. The life coin accounts reflects the result of the transaction following round 1.

The voting of round 2 are: Dave votes green but all the other vote blue. So Dave receives 1 coin from his five fellow competitors, the result by order: 6, 3, 3, 9, 6, 3. This round the demon is activated and ‘eats up’ Bob, Carla and Fred who all are left with 3 life coins and have no one who has less coins to point to.

This action leaves Alice, Dave and Eve as competitors, for whom round 3 applies. In round 3 Alice and Dave select blue and Eve selects 4. This leaves the three competitors with life coins of 5, 8, 8 respectively. The demon is activated, so Alice is removed. in round 4 both vote green, the demon is activated so both are eliminated in round 4, which leaves the life span of the 4 competitors to be: 3, 2, 2, 4, 4, 2

FIG. 4 Unrestrained Privacy Coins Strategy

This figure shows the profit over time for the mint and for the public. The graph exhibits the privacy coin surcharge over time for the case of unrestricted supply. It starts with an arbitrary surcharge level S1. M1 coins are sold until the demand is satisfied and the expiration date draws near. At some points holders of privacy coins who have no good reason to use it soon, are afraid to lose the entire coin value if the coin is not redeemed by the expiration date, Exp. So these holders start to offer their privacy coin at a price lower than the nominal surcharge set by the mint. The mint runs out of business, and transactions happen within the public. Coin holders make profit, or rather lose less than the surcharge they originally paid.

FIG. 5 Successive Rounds of Privacy Coins

This figure shows three successive privacy coin releases. Each release starts shortly before the previous release expires. By setting such releases, the mint forces the public to cash in the outstanding privacy coins and purchase new ones so the mint makes the money from the sale, not the traders who sell their holding. As depicted launch date L2 is a bit before the expiration date E1 of the former release and so it goes.

FIG. 6 Privacy Disabled Zone

This figure depicts the kind of transactions for which the prevailing authority will allow privacy maintaining transactions versus transactions that have to be carried out with mandated degree of visibility.

FIG. 7 Privacy Shopping v. Surveillance Shopping

This figure depicts the two options given to consumers: use non-privacy coins where transactions are registered and are open to the mint, and to any authorized surveyor, and privacy coins that are bought for a surcharge and can be used to buy merchandise without identifying the buyer. In both modes the consumer buys a BitMint digital coin from the mint (essentially a money claim check), passes the coin to the merchant. The merchant may redeem the coin for its nominal value, or may hold on to it if the expiration date is far enough away, and possibly use it for their own privacy preserving purchases.

FIG. 8: Privacy Coins Supply Management

This figure shows prospective dynamics of privacy coins. At time point T1 the mint announces a privacy coin round with surcharge of S1. The mint is offering m1 privacy coins at that surcharge. At time point T1 the mint is done selling all the m1 privacy coins. Any further demand for privacy coins can only be satisfied from privacy coin holders who will make a profit by selling these privacy coins at a price higher than S1. The greater the demand over the limited supply the higher the street price rises for the privacy coin until at time point T2 it reaches a level T2, as represented by an ad-hoc exchange center for the privacy coins. The mint then takes advantage of the higher street price and issues another release of m2 privacy coins denominated at the street price of S2, larger than S1. This offer stabilizes the price of the privacy coin for as long as coins last. When the last coin of the m2 package is sold, (time point T3) the price will go up again, because of the ongoing demand for privacy transactions while the supply is bound. This creates a price hike from T3 to T4 at which point the street price rises to S3 larger than S2. The mint then issues another package of m3 privacy coins, now in the higher price of S3.

At time point T5 the last m3 coin is being sold, and owing to the growing proximity of the expiration point the price of the privacy coin goes down until at time point T6 it is at a surcharge of S4 which is a new minimum. In the figure the mint is shown to issue the last set of privacy coins for that round of coin, m4 coins are sold until time point T7 from where the price collapses to zero at the expiration point.

FIG. 9: 2LAST Cyber Player App Page

This figure depicts a typical 2Last App Page for a cyber player. The player signed up to a game that began on Feb. 13, 2025. The game ID is identified. The original number of players was 2055. The admission fee of say 25$ is not written on this page, but in that case the distribution fund F will log $51,375. The 2Last entrepreneur will take $5000 as operating cost plus profit, the designated charity will receive $25,000, and the balance $21,375 will be awarded as the winning prize money. Assuming 4 players will share the winning prize then each player will receive $5343.75, a return of 214 fold on the investment of $25. The page shows that only 89 players have survived through the 43 rounds played so far. The next round is being closed at 14:00 eastern time. The player may be passive. His phone will use a built in pseudo random source to vote for that player. Alas, the player can exercise their right to vote and actively make a choice, overriding the auto-pilot choice—as long that the human vote is done on time. The page indicates the time left at the present moment: 1 hr and 12 minutes. The page indicates that among the 89 surviving player the richest one or more have 37 life coins in their account and the poorest have 6 life coins. The player has 24 coins—quite high. The wealth distribution of life coins is also depicted on a graph. The page indicates that for the next round the chance for the “killer shark” to be activated is 45%. The option to vote is also on this page.

FIG. 10: 2LAST Cyber Player Elimination Notice on App

This figure shows the ‘sad notice’ to the player that in the last round, round 67 the “killer shark” has got to him. That means the player's life coins account was one without having any player with a lower count. The page does not say (it could) how many players have been eliminated in the very same round.

### 2LAST: AN UPGRADED CHARITABLE LOTTERY

### A Socially Minded Educational and Entertainment Game

### Detailed Specifications

Overview: in a regular lottery randomness determines the outcome, no room for human reasoning; presenting 2Last, a lottery process where randomness shares control with the human mind, creating a challenging, educational, and more entertaining tool to raise money for worthy causes. 2Last is a highly flexible game where players are challenged to pay attention to each other, build a collaboration-competition balance between acquaintances and between strangers, and are challenged to study a particular field of knowledge featured in the game. Unlimited number of participants, (two and up), local or remote, rich variety for allocating prizes and monetary rewards on top of a sizeable charitable contribution; requires little overhead, run by a game master, audience oriented, rich with implementation options. Can be implemented with prime purpose being, training in communication and collaboration, education and entertainment.

2Last attracts special interest because of its utter simplicity, and its structure: to win, one needs to belong to a minority, but if members of the majority rush to the winning minority—they flip the minority into the losing majority; hence the winning moves, per each round of the game can only be probabilistically reasoned. Unlike a regular lottery 2Last participant gain advantage through correct anticipation of what the others would do, and through collaboration—that's the key challenge!

Essential procedure: participants initialized with “game coins” also regarded as “life coins”, respond (vote) to a binary question. Once given, the answers are revealed:

players who voted in the majority are paying one game coin (or more) to the minority voters—that is one round, which is repeated. In one embodiment of the 2Last game, players have a well-defined freedom to communicate and collaborate. After each round a ‘shark’ may randomly appear (or not) and devour all the players who cannot point to another player who has less game coins than they have. The remaining players are challenged with more rounds until no more players remain. The longest lasting players are the winners. Groups of such players may compete against each other for group longevity. The binary question may be explicit: e.g. choose between blue and green, or it may be implicit: a statement of knowledge in a particular field is stated and players vote true/false; yet the reward is based on minority/majority count as described.

2Last may be played with minimum props by a group in a room, or played in cyberspace through a shared phone application. 2Last can be played with unlimited number of participants, players may be organized as 2Last clubs challenging other clubs.

### Introduction

For a social game to capture the imagination and interest of players and provide entertainment and education, it must resort either to randomness, or to a non-trivial, yet non overwhelming intellectual challenge—or a combination thereto. This insight guides the design of 2Last, a game where two or more competitors are trying to outscore the others.

Normally anything of value attracts interested parties, the price goes up, and if there is not enough of it it becomes a desired majority of greater and greater value. So it is with stock, with residential areas, with customs, etc. It is therefore of interest to create a situation where a state of rewards and attraction is tied to this state being a minority-shunned by the majority. Once recognized as attractive and rewards bearing this situation, it attracts more and more participants, but in this trend the minority loses it minority status and hence its attraction. If this flip happens in a binary state then one state is a minority and another a majority. So if things are happening in rounds, and in a given round one binary option, let's call it the “blue” option was the minority, and its opposite option, let's call it “green” was the majority then the blue-holders are rewarded and the green holders are taxed. If in the next round, many “green” players opt to switch to “blue” to gain the rewards, then blue becomes the majority choice, and the rewards are allocated to the green holders. This flip-rule creates a balancing challenge for the players: is it smarter to choose the binary option that was well rewarded in the last round, or assume that others would rush to it, and thereby turn the recent majority into the new minority. It is a dilemma reminiscent of the famous prisoner's dilemma. There is no clear choice. Optimization depends on assessment of what the others will do. This game can be played with or without communication options between the players. Any coordination is suspected for being abridged by a seemingly coordinating player opting for a better benefit by straying from what they said they will do.

As rounds are played the assets that represent the rewards to the minority paid by the majority are shifting among the players. The game can be ended at an arbitrary point, comparing the assets claimed by each player.

In the nominal base version a killer demon is introduced. This is a randomized “killer” that has a known probability to rise after every round and devour all the players that cannot point to another player who has less assets (fewer game coins) than they have. The coming rounds refer only to the surviving players.

So defined it is clear that sooner or later all players are being “killed”, and can be compared through their longevity in the game.

The life span of each player is measured by the count of the round after which it was killed. A group longevity is measured by the sum of the longevity counts of their players. So two or more groups of equal number of players can compete with each other and compare their group longevity.

The group against group competition makes it immaterial what each individual player in a group is scoring longevity wise, only the group sum matters. This places a strong coordination challenge on the competing groups, how to build a winning strategy.

Much like chess, 2Last is a game of rounds where it is mandatory to evaluate what the other side is doing. Unlike chess, 2Last has a randomized element; the probability for the killer demon to bite. By making this probability either 100% or 0% the randomization factor is removed.

The binary selection of the player is the key action of the game. This question can be made explicit, say choose a color: blue or green, or it can be made implicit, namely a statement is given to which the player is asked to say whether the statement is true or false. Another variation: two statements are made, a and b. Next to them there is option c: both are true, and option d: neither is true. The right selection is true, all other selections are false. When the results are evaluated one counts the answers marked “true”, versus the answers marked “false”, to determine minority/majority, not whether the answers are true or false per the statements per se.

This true/false version tests the knowledge of the participants in the field of knowledge from which statements a and b are drawn. This knowledge is necessary for team coordination. Because players may not know ahead of time what question will be asked, they can only coordinate by saying one will vote the true answer the other the false answer, but to do that both coordinating players need to know which option is true and which is false. So players with the implicit question will be tested per their knowledge of the field that supplies these statements for the implicit question.

For example, players decide to vote on questions taken from the Bible. The question presented in 4 statements:

A. King David is the father of King Solomon B. King David is the son of King Saul C. Neither A nor B is true D. Both A and B are true

Any 2Last game participant who selected option A will be registered as correct, players who chose any other options will be registered as incorrect. If 10 players are involved and 3 choose an incorrect options, while 7 choose the correct option then the majority of 7 will pay life-coins to the minority of 3. This puts an extra burden on the participants trying to expect what the others will do.

This implicit form allows the game master to ask different questions to different players. One player may face only one statement, say “David was the son of Goliath” for which the answers also come down to correct and incorrect (or true or false) and despite the fact that different players replied to different questions their true/false correct/incorrect answers can be group counted to determine majority/minority relationship.

2Last is easy to learn, one readily plays the game. It is easy to put props and set up the game, but it is open-ended challenge as to winning the game. Strategy and options depend on how many players participate, what is the probability of the killer demon to strike, what options do the players have for communication and coordination: all with all, parties with parties, in confidence, or in the open?

2Last is fast-pace, entertaining, a means to teach communication and coordination and a means to learn a subject matter covered by the implicit binary question.

An intrinsic challenge for 2Last players is to win against randomized play. In a randomized play all players select their binary answer randomly. For any number of players the expected life span in a randomized game can be either analytically deduced or found out using the Monte Carlo method. Is then coordination improving the result of a player?

Similarly for groups as a whole, is the sum longevity of a group higher then this sum under randomized play?

2Last is an ideal setting to test collaborative AI. It is challenging for AI to play against humans and against itself. 2Last can be used to test new AI entities, checking how fast they understand how the game is played.

2Last flexibility is further demonstrated through the ‘late add-on players’. A 2Last game rolling for some rounds, losing perhaps some players to the demon, then one or more players may be added to the fray. They may have any number of asset units, or say ‘game money’ to play with. There is a strong rational for such mid play players add-on when the play involve investment and profit.

2Last v. Standard Lotteries

A lottery holds an attraction over people because it is pure luck, no intervention of human thinking and reasoning, so smart and no so smart people have the same chance of winning. The idea is that the price of participation is small, the number of participating players is large, so there is enough money aggregated to both make a strong charitable contribution and to award large sums of prizes. By keeping these parameters in tact, and adding human reasoning to the fray, 2Last preserves the charm of a lottery and upgrades it with an element of human thinking having an impact.

The lottery is deemed random, and one would say that the choice of people in a binary field is not random. However a regular lottery is run through mechanical complexity of rolling balls or a similar contraption, it is not quantum grade randomness, it is complexity based randomness, which is also the case with 2Last. The choice what to vote can be purely randomized or it can be probability wise reasoned. The more so with respect to knowledge reflecting binary questions, and subjective binary questions.

### Investment and Profit.

The 2Last players may be asked to put up each a sum x of real money ($), thereby creating a fund F=nx, where n is the number of the starting players. The fund F may be given to the winner or divided between the winners if there are more than one, or it may be scheduled: for example 0.5F goes to the ultimate winner if it is single (the ones with the longest life span), 0.25F goes to the second high life span, and 0.125F to the one with the third high life span, etc. Not working if there are more winners in each class. In that case a different distribution formula needs to be established.

Played for money 2Last may be benefited from a mid game add on player who will have to put up a sum y of real money ($), and start the game with q units of game assets (game money). The higher q, the higher y. The rules for add-on can be fixed ahead of the game or can be agreed upon live by the players who are already in the game. The add on of one or more players, increases the value of the fund F, makes the stakes higher and the interest too.

2Last can be played as “solitaire”, self-play. The singular player will ‘own’ some n players, and will set up their answers each round, activating a randomized killer demon. The player might pre-decide on a number of rounds and then score themselves by the total lifespan of the players. Such super-solitary player will play against his own record, or against a record logged by other solitary players. A natural reference score is the randomized score, achieved on average by having all the players answer all the questions randomly. As described the expected score from randomized play can be deduced analytically or through the Monte Carlo method. The randomized expected result will serve as a reference point for the solitaire player.

Another degree of freedom can be devised through setting up the activation probability for the demon. One of many ways to do so is as follows:

Let r be a positive integer, and let regard q=1/r as a probability unit. A solitary player may set up to play t rounds of 2Last. And set up to allocate z probability units for the full game. 0<=z<=qₜ. The allocation of z₁, z₂, . . . zₜ probability units for the t rounds is subject for optimization z₁+z₂+ . . . z_{y}=z. Several limitations for the allocation of the probability units and their number may be agreed upon. It will give an open challenge to the single player and it can also be applied such that a player has the power to allocate probability units to their opponent.

Example: for playing 12 rounds, let r=4, so a probability unit q is worth ¼=25%. Z is agreed upon as z=24. The allocating player can set up the demon to be activated at a probability 50% (2 probability units) for each round: 2*12=24. Or the player can allocate zero probability for the demon to strike for the first 6 rounds, then allocate a 100% striking probability for the subsequent 6 rounds. Or perhaps 25% striking probability for the first 6 rounds, and 75% striking probability for the latter 6 rounds.

The idea of a ‘super player’ who takes the role of two or more players, can also be used to allow two people to play 2Last. They would each be responsible for the same number of regular players, that means they would decide for the players they handle what the answers would be each time around. After pre-set number of rounds or when the game is over (everyone killed) the two super players will compare the sum of the lifespan of their players, the highest score wins.

2Last being essentially a communication and collaboration challenge, it can be played with various settings of communication and collaboration possibilities. On one hand is the state of zero communication between the players, as they consider their answer for the next round. On the other hand is the full open communication where anyone can talk to anyone with everyone hearing all that is said. Between these two end states, there are numerous in between states, where players may reach out to any other player in particular and exchange information that is not disclosed to the rest. Some states will dictate that different players have different communication challenge to different other players.

The Essential 2Last trap: in a normal social influence situation, an influencer has the power to sway his followers to follow his orders (or her orders as the case may be). In the 2Last environment this power is challenged. Each follower says: many people follow this follower, so many people will do as he says—that means they will become a majority, namely on the losing side, so I better be taking the opposite side and be part of the winning minority. But then again, each player thinks, most other players will think like me and take the opposite side making it the majority, so after all I better follow the recommendation of the influencer I follow to end up in a minority! It is a built in confusion. For influencers there is the challenge how to exercise their influence despite this confusion.

### 2Last Single Group

Defining the 2Last game as follow: Elements:
1. n players (nominally people)
2. a Life Bank
3. a killer Demon
4. life-coins
5. game communication system
6. a stage
7. a game master

The stage is the setting where players are situated so that they can communicate with each other, act (vote) and see the life-coin status of all the other players.

Operation: the game master seats the players in a setting (stage) where they can see each other, communicate with each other, and see how many life points (life coins) each player has. The players all consent to play.

The game master runs the life-bank which is a repository for life coins of a number as large as necessary.

The game master begins by handing to each of the n players a starting account of s life coins each.

If the setting is in a shared room then the life coins may be physical buttons, or clear shape entities that can be mounted into a stack.

The game master announces a time scheduled for round 1 in which the game master will ask the players to choose between a green color and a blue color, (the explicit question version) each makes their choice privately and when all choices are made, the choices are made public for the entire community (group) to see. Note: we use here blue/green by any pair of colors or option will do—the game is the same with either choice.

In the following eventualities nothing happens in terms of life coin transactions:
1. all the answers are “blue”
2. all the answers are “green”
3. half of the answers are “blue” and exactly half is “green”

Otherwise let b players choose blue and g players choose green. Every player from the original group of n players must choose a color. A player who refuses to make a choice is “killed”—taken out from the group. Assuming all players chose a color we have. b+g=n.

If b<g, then every player who chose green is losing a pre agreed number of life coins. Nominally the loss will amount to a single coin, which is passed to a ‘transactional account’. The transactional account is then distributed among the b blue choosers, as follows:

### Transactional Account Distribution:

The initial sum in the transactional account, T, t, is t=g life coins collected from the g green choosers (voters),
Steps: TAD-1: if t/b is an integer, then each blue voter is given t/b coins—distribution is complete. Otherwise:
TAD-2: the life-bank adds a life coin to the transactional account incrementing the value of t by 1.
TAD-3: return to TAD-1.
Example: let b=5 and g=7. Initially the transactional account contains t=g=7 life points. Since 7/5 is not an integer, the life-bank increment the transactional account to t=8. 8/5 is not an integer either, so another increment t=9, and then another increment t=10 where 10/5=2, and each of the b players receives 2 life coins.

A completely symmetric action take place in the opposite case where g<b.

Once the distribution is complete, the game master invokes the killer demon.

The killer demon is randomized; it operates under a game agreed ‘killer probability’ for each round. pₖ, this is the probability for the invoked demon to act, namely to kill players. A random source will select a number k between 0 and 1, 0<k≤1. If. k≤pₖ then the demon kills players, otherwise, the demon ‘goes back to sleep’ and kills no players.

If the demon is charged to kill players it does so by killing all the players who cannot point to another player who has fewer life points.

Illustration: n=12 players. They all get s life coins to start the game with. The answers to the demand to pick a color resulted in 6 choosing green and 6 choosing blue. Nothing happens, all players have the original s coins each. Let pₖ=0.35. The randomized selection for the killer prospect k=0.30. Since 0.3<0.35 the demon goes forth to kill players. Since half the players chose blue and half chose green, no transaction happens, all players hold s life coins, no player can point to any other player with fewer life points, so all players are being killed. Note: that it why it makes sense to allow the first round to run without invoking the demon before some distribution develops with respect to owned life coins.

If 5 players picked blue and 7 players picked green, and the demon is activated then the blue pickers end us owning s+(7+3)/5=s+2 life coins, and 7 players who picked green claim s−1 coins, they lost one coin to the transactional account. The 7 players who picked green cannot point to any player who has less life coins so they are all doomed—killed. The community of players will count now only 5 members.

Round one ends: the binary question is asked and answered, the transactional act is done, the killer demon is activated—it kills or not and the round ends.

Next the game master launches round 2, which is the same sequence of round 1 only that perhaps some players have been outed, and perhaps not all players have now the same amount of life coins. Round 2 ends up killing players, or not, and is followed by round 3. And so on until such time that the last surviving player or players are being killed.

Each player i of the original n players has been killed in round rᵢ. The winners of this 2Last game are a group of players W, comprising w players such that for each player j E W it holds that: rⱼ≥rᵢ where for i=1, 2, . . . n

The group or community score as a whole is. Ω=(Σrᵢ)

### Illustration

Alice, Bob, Carla, Dave, and Eve are 5 players in a 2Last game. Each gets s=4 life points. pₖ=⅓.
Case 1: no communication, no coordination, each player thinks for themselves.
Round 1: the answers of the 5 players is by order: b, g, b, b, g. (b-blue, g-green). The ensuing transaction yields the following life-coin accounts by order: 3, 6, 3, 3, 6—the blue voters lose a life coin, the bank adds a single life coin to the three collected coins and divides the 4 coins between the two green voters.

A dice is tossed, it's agreed that if it shows 1, or 2 the demon is activated, otherwise not, to express the agreed upon chance of activation being 1/3. The dice shows 4—no “killing”.

Round 2: the answers: g, g, g, g, b. Apparently 4 players thought that green is a choice for winning. The resultant life-coin accounts by order is: 2, 5, 2, 2, 7—4 life coins are collected from Alice, Bob, Carla and Dave and given to Eve.

The die is tossed again, 1 comes up, so the demon is activated. Alice Carla and Dave are the players who cannot point to another player with less life points so they are “killed” by the demon. We account for the living versus the death with a “life-count”: C. C=0 for a player means the player is still alive, C=r, where r is a positive integer reports the round (count) when this player was killed. So the initial life count by order is: 0, 0, 0, 0, 0, and the life-count after round 2 is: 2, 0, 2, 2, 0
Round 3:2 players left: Bob and Eve with life accounts by order: 5, 7. Two people cannot come up with a minority majority set up so their relative ranking will not change. Eve is the winner because whenever the demon will strike again, he will strike Bob not Eve

The game could have been played with the 5 players each puts forth a sum of money, say $100. Plus each player pays to the game organizer a fee. The total fund of $500 is then divided to the winner, in our case Eve getting $500, making a profit of $400 in the game.

Cooperative Game: we illustrate now a situation where Alice, Bob, Carla, Dave and Eve decide not ‘fight,’ not to disagree, and they resolve to give the same answer each round. Using the same dice results as above, the five players answers b, b, b, b, b in the first round. No transaction, no killing. They answer the same in round 2, but this time the demon is activated and kills all the players because none of them can point to a player with fewer life points. The life log now looks: 2, 2, 2, 2, 2.—all players died in round 2.

In general the 2Last game challenges the players to improve upon randomness, which is not easy to do in this setting.

The lower the killer activation probability the more room for strategy for the players.

### 2Last Groups Challenge

n 2Last players may be organized into g groups where each group has d players, n=gd. In parallel to the individual competition between the players, the g groups can compete too. The score of each group will be computed as the sum of the life span of all its members. Groups will compete per their score.

Players can then pay a regular pay fee, p, plus a group fee, p*, creating funds F and F* respectively. F=pn, and F*=np*. F will be distributed according the scored life span of each individual, and F* will be distributed according to the standing of the competing groups (per their scores).

This allows player to sacrifice their individual standing in favor of their group standing.

Groups can be organized as super groups and so iteratively many times. Each hierarchy will compete its own.

### Binary Question Upgrading

The base 2Last calls for a repeat binary question, codified as choose between green and blue. This binary question can be upgraded in several ways:
1. new round, new question
2. objective question
3. subjective question
4. opinion question

### New Round, New Question:

Instead of repeatedly asking blue/green choice, different colors or different choices. For one reason: it forces the participants to think for a moment of the premise presented in the binary question.

### Objective Question

The question has a correct answer.

In a simple mode the objective question is a statement that is objectively true or false and respondents are asked to choose between true and false.

In an extended mode the question structure is as follows:
1. Statement A. (true/false)
2. Statement B (true/false)
3. Neither is true.
4. Both are true.

If A is true then respondents choosing A are considered color black, the other 2 responses—red.

If B is true then respondents choosing B are considered color black, the other 2 responses—red.

If neither is true then respondents choosing “neither is true” are considered color black, the other 2 responses—red. If both are true then choosers of option “d” are black, the other red.

### Subjective Question

The binary question might be subjective, a matter of taste, and this adds a consideration for the voters, asking themselves, as they should: which is the answer most people will give. For example: statement A: “France is a more attractive country than Spain”—yes/no? A participant evaluating that most players will agree, will say ‘no’.

### Opinion Question

The binary question may be an opinion type “there will be war in the middle east this summer” yes/no. It may be a question of taste: “Is a pizza better than a steak?” In all these questions, the count of the choices is what counts. The advent of 2Last is that it is equivalent to asking the question: what do you think most people think?

2Last can be implemented in a large variety of options. We sort out these options as follows:
1. virtuality status 2. casino status 3. fund raising status 4. audience status 5. binary question 6. number of players

### Virtuality Status

2Last can be played face to face by players sitting around a table playing. It can also be played virtually by players around the globe, all communicating with the game master and among themselves as agreed upon. The virtual players may be acquaintances, or may be strangers. In fact players may be totally secret, towards other players and towards the game master.

### Room Implementation

We describe a small number, n, of individuals gathering around to play 2Last. One of the players, or an additional person, serves as the game master.

Here is a possible simple implementation: A deck of cards is used as props. The group of players decide on a starting level of life-coins, (game dollars), s. The designated game master deals out s cards featuring 1 to 10, to each player (using more than one deck of cards if necessary). Each player displays their cards face up and in. countable mode. This is the life coin display of each player.

The game master further deals out one red card of monarchy (kind, queen, prince) and one black card of monarchy to each player. These are the voting props. (more than one of each color can be dealt too).

The game master makes sure he has a reserve—red, black as the binary choice of 1-10 cards piled up as a life-coins bank.

Now the game can begin. The game master announced the first question. It may be explicit, or implicit. If implicit, it may be the. same question to all players or a different one for each—all require binary response correct/incorrect true/false, and the count of each reply is what counts.

An explicit question will be for all players: what will be your choice for the next round, black or red. The players will use their monarch cards to express their answer, lay the choice card face down on the table. Thereby all the players vote by selecting a monarch card, red or black. When all players have placed their answer (face down card) on the table, the answers are unchangeable, and now the game master orders all the answer cards to be turned up, and expose to the entire room the minority/majority status of the collective answers.

The picture is then clear to all. Perhaps there is no transaction, and right away the killer demon (the shark) is activated. If there is a minority/majority situation then every player who voted the majority way is paying one life-coin to a transactional fund, F (The game can be defined with other payment schedules).

The life-coin (game coin) is represented by a card from the s non monarch cards held by each player as game starting life money. Out of the n players n* gave the minority answers and n** gave the majority answer so that n*+n**=n and n**>n*. The transactional fund F receives n** life coins. if t=n**/n* is an integer, then each of the minority answers givers receives t life-coins (cards), to the existing cards to its life-money cash register. The total life coins throughout the group of players is the same. The majority gave n** coins which were distributed by giving n**/n*=t life-coin to every minority voter.

If n**/n* is not an integer, then the life-bank adds coins to the fund F, until the number f of life-coins in F is such that t′=f/n* is an integer, and then each minority voter gets t′ life-coins, cards to its account. The total number of coins in the group is the original sn coins plus the coins added from the life-bank, so total coins is: ns+(f−n**).

The transactions of the cards (the life coins) is handled by the game master who is also in control of the life bank,

At this point the transaction is concluded and perhaps the accounts of the players have changed.

Now it is time to activate the killer demon. One easy way to do so is with a dice or two dice. For example for implementing a killer probability of 1/3, the game master will throw a dice. If it shows 1 or 2 it is a kill, otherwise—pass. To implement a killer probability of 10%, the game master will throw 2 dice. If it shows 2 then it is a kill. If it shows 3-11—not kill. If the two dice show 12 then, the dies are thrown again. If the killer demon is activated, then all the players who share the lowest account sum are being eliminated.

The game continues as long as the pre agreed number of rounds has not been reached, or as long as there is any player left the rounds continue.

At the end of the game if by rounds then the surviving players are the winners, the killed players are the losers. If the game ends when there are no more players (all killed) then each player is noted by the count of the round when it has been killed (its life span). Alternatively, the game can be played by the clock. The players with the higher life span are the winners. The game can be played on recognition basis—the winner or winners are recognized as such.

Otherwise the game can be played for money. Each player puts up a sum x$ to build a distribution fund D=nx ($). If there are w winners then each winner gets nx/w ($).

Players control the time length of the game by choosing how it ends and by choosing the value of s, the initial count of life coins per player.

### Implicit Binary Question

The binary question in each round in the base version is explicit: red or black (green or blue) and the players respond with a card of the selected color. The people in the room can also play with an implicit question for which the answer true will translate to a black card and the answer false will translate to a red card. The players can take turns presenting the questions which they will have to answer too. After voting (replying to the binary question) the players may debate if the statement was true or not, which in any case does not change the dynamic of the game.

### 2Last-Cyber

The 2Last players may be situated in cyberspace; fully or in part. They may know each other or be strangers. They may be a few, or may be a crowd.

A virtual game will require a game application to be played on computers, phones or any other devices. Implementation may take different routes.

Considering:
1. private implementation
2. centralized implementation

Cyber implementation will involve a central service website (2Last main) with associate database and links to a financial institution for both classical payment and digital payment, for payment involving games.

### Private Implementation

In a private implementation, a desired game master will register with the 2Last Main website to be regarded as a game master. The registrant will be offered various sets of game rules to choose from. In advanced situations the game master registrant will determine its own rules.

If the planned game involves true/false questions for knowledge examination then the registrant will be directed to various topics offered by the 2Last Main to be used as the binary questions for the game. The registrant will be able to offer a set of such questions on his or her own, to be used randomly or by an arbitrary order by the Main website.

Once the terms of the game are set, the game master registrant will be offered the option to recruit players on his or her own, or to request that 2Last Main will search for players. The number of desired players will be set by the registrant. The killer probability schedule per each round, is also set by the registrant and the 2Last will comply. Same for initial life-coins count, and the terms for termination of the game (complete run or per number of rounds). The registrant also selects starting date and time and interval of time between rounds.

The level of communication between the players is also determined by the game master. It can be zero—none contacts anyone else, they may also see each other's voting record. It can be open where any communication from any player to any other player is open to all, or it can be partial, where communication happens according to specific rules, say, every player can choose two other players to communicate with.

If money is involved then the 2Main will be responsible to collect the play fee from all the players, and then to distribute the collected fund according to instructions from the registrant.

The 2Last Main will collect participation fee from the players when they are registered, if applicable, and together with the fee charged to the game master registrant the 2Last enterprise (that run 2Last Main and the entire 2Last operation) will cover its operational expenses and its intended profits.

The registrant will set the rules for fund distribution. Depends on the case, a pre allocated portion of the fund may be used to support a charity (and thereby pull in more players), or may be pre-taxed so that the prevailing authority will authorize the game, or both.

Payment can be done in a classic mode, bank accounts, payment cards, etc. or it may be carried out with digital money, where BitMint is a most appropriate money format for the purpose. It assures anonymity which might make the game very attractive.

The registrant will specify if and on what terms to accept new players after the rounds have started.

When all the parameters are set, the Main website determines the fee if any collected from the registrant for the service. It provides a secret game key (and a game id) for the registrant to pass along to players he or she brings aboard.

Each of the players recruited by the registrant will log in to 2Last Main, provide the game id and the secret access key, pay players-fee and be listed for the game. Short time before the first round is activated all the players and the game master will receive a notification to that effect. Each round will have a start time and an end time, a window of time given to the players to place their vote. Each player is associated with a random binary answer that stays in force unless the player changes it. Thereby when the round voting is done, all votes are in. Once all the votes are in, the 2Last Main website determines the life-coin transactions, evokes the killer shark, (the demon) to rise or sleep, and report the state of the game after the transaction and the possible loss of players. Then the players wait for the next round, and so on.

Each player is provided from the 2Last Main a summary screen of the account and longevity of the players to help in deciding on the next vote.

When the game is done, whether by having no players left, or by arriving at the pre determined number of rounds, the 2Last Main is computing the end status, distributing the money fund according to preset rules, and reports the result to the registrant for game manager and to the players.

### Centralized Implementation

The 2Last entrepreneur will announce 2Last games, specified with terms and timing, Number of participants (range), admission fee etc. In that case the central website will serve as the game master, and manage the steps to be taken. There will be games of various levels of admission fees, various types of binary questions, and various number of participations.

The 2Last will be usable to support a charitable cause by pre allocating a sizeable cut from the distribution fund to the designated charity, which in turn will attract participants.

For example, the 2Last enterprise will announce a 2Last game to be started February 1^{st}, will run once a day (1 round per 24 hours) until completion. Play fee, will be p$, the game will be played with n players, or more. In service of a non-controversial charity that will receive a portion c from the fund collected from players fee. The 2Last contribution will be to waive service fee—in whole in part. The game will yield a benefit of cnp to the charity. The number of players for whom there is no player of longer life will be I so each of the l winners will receive (1−c)np/l $. So for n=100000 and p=25$, we have F=2,500,000$. Half goes to the charity: $1,250,000 and the other half is distributed among 50 winners: $25,000 each.

The game can be accelerated by playing a round every hour or any other timing schedule.

The game master (the enterprise) will decide on a communication arrangement, perhaps a free “shout-up” for any player to any particular player. The players don't need to use their own name, they can use a play name. If the payment is carried out with BitMint private coins then the identity of a player may be left unknown to anyone.

The 2Last system will also provide a video option for winners and losers to go wild before their phone camera for the entertainment of others.

There may be many 2Last games in parallel. In different times. The central service is to be designed of large capacity to handle parallelism.

The central site may also announce groups competition, asking for several groups of players to register as a group for a tournament of games, to determine the most competitive group.

### Off Coordination

2Last players could coordinate and come to agreement off the game. A subset of players may decide to share profit and thereby to forgo personal interest in the 2Last game for the group to win more. Such coordination may not be known to others.

In various implementations one particular player will take the role of several players, so they are intrinsically coordinated.

### 2Last Combo

Let 2Last-A and 2Last-B be two distinct 2Last games having nₐ and n_{b} participants respectively. Let each game be run with a different binary question, so for game A the binary choices (votes) are Uₐ, and Vₐ (say Uₐ=blue, Vₐ=green), and for game B the binary choices are U_{b} and V_{b} (say U_{b}=plus, and V_{b}=minus). The two games may proceed independently from each other but at some point they may be joined as follows:

First the choices will be coordinated: Uₐ is matched to U_{b} and Vₐ is matched to V_{b}. Then the two games will run separately as before but time-coordinated. So that at a given time t the voters of both the A game and the B game have voted. Next the votes are counted across the two games (that is the essential element of the ‘combo’). Let n′ₐ players vote Uₐ and n″ₐ voters vote Vₐ, and let n′_{b} player vote U_{b} and n″_{b} players vote V_{b} choice. Clearly n′ₐ+n″ₐ=nₐ and n′_{b}+n″_{b}=n_{b}

One now compares the u “U voters”, where u=n′ₐ+n′_{b}, with the v “V voters”, where v=n″ₐ+n″_{b}. If u=v, or u=0, or v=0 then no transaction happens. If u>v then the u voters contribute a life coin each to the round fund, and this fund, with w coins add-on from the banks, where w is the smallest number such that q=(u+w)/v is an integer, is divided to the v-voters, each v voter receiving q life coins. And the symmetric opposite happens if v>u.

Following the combined transaction, the invoked shark (demon) may be a combined shark, or each game will have its own shark.

Following the combined round the two 2Last games may separate or re-combine, as they choose.

Such 2Last combination may take place with three or more individual games.

### 2Last Split

We consider a situation as described above in the 2Last combo section. Let the two games use the same binary question each round, and let them play combined rounds from round 1 and on. Let they share a bank and share a shark. In that case the combined 2Last-A and 2Last-B game will play as a single 2Last-AB game with n_{ab}=nₐ+n_{b} players. This unified 2Last-AB game can readily split to 2Last-A and 2Last-B. So can every single 2Last game. Much as 2Last combo can apply to three or more combining 2Last games, so the split applies to any number of split games (as long as there are players to split).

### 2Last Split and Combo

Both split and combo are general and add degrees of freedom both to the 2Last organizers and to the players. For example the rules may be such that a majority of players can vote to boot out the players who have a very high life coins account, in order to give the rest a chance. In such forced ouster it will be fair for the booted group to claim a portion of the distribution fund F commensurate with the booted group scoring in the life coins account.

### Mega State

2Last will be most effective as an upgraded lottery if it applies to a very large perhaps international crowd. The timing between rounds is fully controlled and it is not necessary uniform. There may be many millions of players on a given game, in which case players will not see the identities of the other players, only be informed whether they are on the winning side or the losing side.

### Pace Variance

2Last can be played at a very fast pace, even just seconds between rounds, or at a very slow pace days and weeks between rounds, and the variance over a single game may also be very large. This, as well as the distribution of the killer probability give the game masters a large degree of freedom to calibrate the game to invoke maximum interest in the target community of players.

### Celebrity Games

2Last can be show played, featuring celebrities seated in a studio, or arrayed in cyberspace. They might sign up for a very high fee, which means that the served charity will be getting a large contribution. The players will be visible to the public as the rounds proceeds every few minutes and the results (life coin accounts, and longevity) are clearly displayed. The tension is growing as the killer “shark” does its thing and fewer and fewer content for the big prize.

### Ranking Options Through 2Last

Let o₁, o₂, . . . oₜ be a set of t options of some sort, which one desires to rank, and use 2Last for the purpose. Here are several ways to doing it.
1. Set up a set of n 2Last players to vote on preference between o₁ and o₂. 2Last transactions takes places per the established procedure. The majority winner is then cast against o₃—creating a second round, with 2Last results. The majority winner of this second round is cast against o₄, and so on the majority winner is cast for another 2Last round against the next option, until an overall winner is identified, and the rest are ranked below.

A similar symmetric procedure will cast the minority winner of each round against the next option (method 2).

A third option will divide the t options to 0.5t pairs. Each pair will be cast as an 2Last round. The winners will play against each other, and so on until a winner is declared. This “tournament method” can also be done by casting the minority winners instead. To work well t must be a power of 2 (t=2^{q} for q=2, 3, 4, . . . )

The voting itself may be specially designed. For example the t options are TV channels. To vote for a channel one has to be turning it on for at least, say 10 minutes. Well done, this will draw audience to less popular channels.

### Admission Fees

Admission fees may be uniform (participation fees). Alas, they may differ for large global games. Different locations will pay different rates. The location of the participant will have to be verified. By using BitMint LeVeL digital money, it would be easy to use the same amount of digital coins for participation fee, while buying these digital coin with regular money will differ from zone to zone.

### Prize Allocation

The allocation of the prize money may be sharp-all goes to the longest lasting players, or it may be ‘soft’ distributed among the players per their longevity ranking or per their life-coins account. The advantage of the latter is that the game may be stopped at any point since every live player has an account with a few or more life coins in it. So 4 participants with longevity ranking 12, 10, 8, 2 will divide the prize as 12/32, 10/32, 8/32, 2/32 portions. In the sharp mode the player with a longevity of 12 will get the full prize 32/32.

Another variety in participation fee may be per the number of starting life coins. Participation fee for starting with 5 life coins might be $8, while participation fee for starting with s=10 life coins will be $25. This will give incentive to participants to pay higher participation fee and increase their chance to succeed.

### The Advantage of Steps

In a typical lottery one purchases a ticket with a number and waits for the results. With 2Last the winner is determined by a series of steps. Participants watch how they survive several rounds of “shark attack” staying in the game another round and another, getting their hopes up, wishing for the next round to come and stay alive. Gradually most, fall off, “die” at one round or another, and then get ready to sign up for the next game-determined to win.

### Auto Pilot

A 2Last registered player (whether with explicit identity or encrypted identity), interacting with the main 2Last website through their phone App, would be by default on “auto pilot” mode. Namely, when the game master announces a new round and the message goes from the 2Last website to the player's app, then the App uses any source of randomness to file with the 2Last website its vote-its random choice. So the registrant once registered does not have to do anything, participation in the rounds is automatic. Curiosity will send the average player to their App to see their status. The status page will set itself to an updated position, listing the count of the latest round, the number of starting players, the number of surviving players to date, the distribution of life span for the killed players, the distribution of life-coins among the surviving players, the value of the highest life-coin account and the level of the lowest life-coins account, the amount of life coins in the account of the player that runs this copy of the app. These numbers give the participating player a sense of his status, and his chances to stay alive and perhaps be the winner of this game. The more frequent the round the more often the curious player will run the app to inspect his status. ‘Of course, the player before any round may shun the automatic choice and proactively vote (choose a binary answer). So the game runs on autopilot by default and runs proactively by the player per their choice.

### Randomness Sources, Oracles

Players may engage their choice for randomness sources, or what they will call ‘oracles’ in order to make the choices for them for various rounds. There will be a market for such oracles, and statistically some such oracles will prove themselves as useful and create a mystical faith in them by their users.

People being prayerful, will pray to a given oracle to help them prevail in the coming or current game.

### The Cyclical Logic Trap

If in a given round there was a predominance of green over blue, then the ‘average player’ is subject to the following reasoning (a): people tend to vote green, so next round I am to vote blue and win!. No sooner would ‘the average player’ declare this logic (a), than they would be struck by subsequent logic (b) that says: most other players will invoke logic (a) and this create a majority for blue, so I better vote green. Alas, no sooner would the average player go through logic (b), than logic (c) comes forth: other “average players” will also go through logic (b) and thereby make green a majority for the next round, so I better buck the trend and vote blue. This leads to logic (d) with the opposite conclusion and on it goes, without a clear stop. So what is the logical player to do? This enigma gives 2Last the spark!

### 2Last Strategies

For large scale (mega participation) games in particular players will develop various strategies and compete with them. For example one strategy will say register to play 2t times (pay 2t participation fees, where t is a positive integer). Vote t players as blue and t players a green. The selection of which player votes which is done randomly. Keep this strategy on and one. When a player is killed, and only 2t−1 players are left, then randomly select (t−1) players to vote blue and (t−1) players to vote green. The leftover player the (2t−1) player will vote randomly. Keep this procedure until you lose another player, now select (t−1) to vote blue (random selection) and the other (t−1) players to vote green. On it goes as one loses players, the remaining players are randomly selected to vote as close to half-half as possible. This “half half” strategy has a logical basis and it would compete with alternate strategies. One could program their strategy into their copy of the 2Last app and apply it automatically

### The Use of Anonymous Digital Money

Large sum lottery winners are often subject to harassment and pressure from acquaintances and strangers alike, which limits participation. Using BitMint LeVeL digital money as defined in the continued U.S. patent application Ser. No. 17/862,285 will allow participant players to sign up with an anonymous ID making payment with BitMint LeVeL coins, remain anonymous, and be awarded a prize, if they are the winners per the anonymous id they used to sign up. They will then receive a big prize but remain unidentified to anyone trying to apply undue pressure on the winners. The private money so won may later be sold out to parties interested in buying privacy as described in the here claimed provisional application 63/641,398,

2Last being used for substantial charitable contributions will be acceptable as a means to clear vague money through privacy provisions.

The referenced provisional application 63/641,398 describes the means to allow people to buy private money. This invention describes an attractive use case for such money. Where people sign up without disclosing their identity and collect, if they win, identity hidden.

### 2Last: Overview

Presenting a method to exercise social communication and coordination in a game, while supporting educational aims, and providing social entertainment; implementable as a charitable contribution, and as a for-profit competition; easy to participate, effective for small groups, medium groups, and very large groups; the method is called 2Last;
the essential participants of 2Last are:
(i) one game master, that determines the rules of the game, (ii) n individual players, competing in the game, the essential elements of the 2Last method are coins designated as “life coins”, a “life bank”, a repository of “life coins;” “binary questions”—questions that limit the possible answers to two, “play rounds”, successive repetition of procedures; “a randomized players eliminator” (shark);
the essential operation of the 2Last method is:
(a) initial settings
(b) a sequence of play rounds
(c) declaration of winners and distribution of a winning prize, if any;
the 2Last process is comprising a sequence of play rounds, where each round leads to a transaction of life coins between the players and the life-bank, and to a chance occurrence of elimination of players who own the least number of life coins; the players who survived the highest number of rounds are declared winners, and share a designated prize, if any; the transaction of life-coins at the end of each round is determined as follows: a binary question that can be answered in two ways only, is presented to the players by the game master; the players answer the binary question without knowledge of how the other players are answering it; when all players have answered the binary question, the game master reveals all the answers to all the players; if all players answer (vote) the same way, or if the count of players who vote one way is the same as the count of voters who vote the other way, then no transaction occurs. Otherwise, the majority voters pay life-coins to a “round fund”, for which the life bank will contribute a certain count of non-negative life coins, and the round fund is distributed equally in units of life coins among the minority voters.

Each round is concluded with a randomized invocation of the “shark” (also regarded as ‘demon’), a process that eliminates from the competition all the players who cannot point to another player who has fewer life coins than they have.

The initial setting comprises:
(a.i) determination of rules, by the game master: how many life-coins, s, are given to each player by the life-bank, creating a game-starting life-coins account for each player; what are the binary questions, the specific protocol for the life-coins transaction per each round, the probability for the shark to be activated after each round, the timings for the round, and the level of communication and coordination allowed for the players;
the players are being allocated s “life coins” each, before the rounds begin, the “life bank” has unlimited number of “life coins”.

The above method can be implemented in a situation where the m majority voters after each round are paying one life coin each to a “round fund”, R, so that |R|=m; if t=m/f is an integer where f is the number of minority voters for the same round, then each minority voter receives t life-coins to their life coin account; and if t is not an integer than the life-bank is adding one life-coin at a time to the round fund R, such that after adding b bank life coins the division t′=|R|/f=(m+b)/f computes to an integer and then t′ life coins are being allocated to each of the minority voters life coins account.

This 2Last method can be implemented in a situation where the player elimination probability is changing from round to round by a rule preset by the game master. Another implementation nuance is where the binary question repeats itself as a choice between two options designated “green” and “blue”.

Another possibility is where the binary questions are statements expressing knowledge from a declared field of knowledge, or expressing a fallacy from the same declared field of knowledge, and the binary questions are limited to true/false; the game life-coins transactions after each round are based on the count of “true” answers versus the count of “false” answers, not on whether the true or false answers are correct or not.

The same method can be used where players pay play fee, p each, creating a distribution fund F, where |F|=np; a pre-determined portion H is given to a declared public cause and the balance np(1−H) is divided equally among the winners: the ones with the highest life span, where life-span of a player is measured by the count of the rounds in which the player was eliminated from the game.

The same method can be implemented in a situation where the n players are organized in g groups of d players each, n=gd, and where individual players compete individually, trying to stay alive for as many rounds as possible, also the g groups are competing against each other, where each group tries to get the highest count of the summary of the life-spans of its members.

Furthermore we can set a situation like in the previous paragraph where the players pay a play fee, p, for individual competition, and the fund F=np is distributed to the winner as pre agreed; and the players also pay a group fee, p*, to a fund F*=np* which is distributed to the winning groups as pre agreed; and where groups can be assembled into super-groups that will compete with each other per the sum of the life spans of groups.

### BitMint Payment Privacy Procedures

Addressing the Universal Demand for Payment Privacy with Specific Application to the Operation of 2Last.

2Last has a global reach, calling for payors from all around the world to take part in a 2Last game. This globality calls for a universal monetary system to handle the admission fee (participation fee), as well as the paid out prizes, and charitable contributions, and also for a universal taxation system. Players may value their privacy both for payment of their admission fee and more so for collecting large prize sums. It is therefore that a universally implemented privacy assuring payment system goes hand in hand with the 2Last procedure. Such system is thus made as part of this patent application.

a Market Solution to the Digital Money Privacy v. Law Enforcement Dilemma

An authorized mint will mint a limited number of BitMint digital coins designated for anonymous trade. These coins will be offered for trade by the mint as a market commodity the price of which is determined by supply and demand. Holders of these privacy coins will be able to pay without exposing their identity. The mint may declare for each coin a date after which the coin is losing its value, so one will have to redeem it before that date. The mint might insist on exposing the identity of the redeemer or not, but the procedure is such that there is no way to expose the identities of previous traders. The mint will redeem a privacy coin for its nominal value. The difference between the price paid by the privacy seeker and the nominal value of the coin is the cost paid for the gained privacy. The mint, as the agency which sells the privacy coins, will make the money per its sale price v. its redemption price. There may be additional conditions levied on privacy coin trade, like the maximum value of merchandise paid with such coins. Certain merchandise, like firearms will be unqualified for privacy purchase. Each society, each prevailing authority, will decide how many privacy coins to allow for the market to be traded with, and under what conditions. Traders not interested in privacy will pay and get paid with non-privacy money.

Let Alice approach Bob for the purpose of buying a certain merchandize Bob offers for sale for $x. Alice wishes to remain anonymous, so she goes to the privacy coins market place and finds out that these coins are offered for $y>$x price. Alice then pays $y to buy coins of nominal value of $x. She pays these coins to Bob. The service of privacy cost Alice $(y−x). Bob can readily redeem the coins for their nominal value of $x. By so doing the mint sealed a gain of (y−x)$ since the mint received $y for the coin and paid only $x. Bob is not losing and not gaining. He is at the same point had his customer not desire privacy and pay non private coins for $x. Bob, may decide to cash in on the privacy money and offer it for sale in the marketplace. He may receive $y for his privacy coin, which will give Alice good ground to negotiate with Bob over a price somewhere between the current x$ and a lower price $z.

### Introduction to Privacy Coins

The BitMint*LeVeL digital money solution allows for absolute privacy exceeding the privacy offered by cash transactions. Cash discreet exchange requires physical proximity and some information about the identities of payor and payee is leaking out. In BitMint*LeVeL only the owner of a coin knows their own identity, not the counter trader, not the mint and not the government. Of course BitMint*LeVeL privacy can be downgraded from this absolute state to any half way state.

By allowing unrestricted use of absolute trade privacy a society creates a trade advantage for the criminal element. Societies therefore may wish to limit such ‘gold state’ privacy to disrupt ill wishing actors.

Such limitations can be in the form of purchase maximum. pₘₐₓ above which no privacy coins are allowed.

A different approach calls for minting two categories of BitMint*LeVeL digital coins: (i) nominal coin, and (ii) privacy coins. Nominal coins will list and identify their full chain of custody, the identity of all historic owners of a coin will be carried by the coin itself. No privacy. Privacy coins will enjoy the full or partial privacy as afforded by BitMint*LeVeL.

The nominal BitMint*LeVeL coins will be issued without any restriction to any members of the public. The privacy coins will be minted under certain restriction rules. Restricting the supply of a commodity in demand creates upward price trending. One way or another the price of the restricted privacy coins will rise above its nominal value. The degree to which the price goes up is the degree to which privacy is important to the trading public. Trade with privacy coins will open a new revenue channel both for the mint, and for speculators. The mint is in absolute control by setting the amount of minted privacy cons and their fluctuating price.

We consider some privacy coin implementation strategies.

### Privacy Coins Implementation Strategies

### Options

1. fixed privacy surcharge unlimited amount
2. Supply Management Strategy

Each of the above strategies may be coupled with expiry terms—a period of time beyond which the privacy coin is devoid of value.

Each of the above strategies may be coupled with pₘₐₓ, a maximum price that can be paid with privacy coins.

Privacy coins give rise to competitive pressures. A set of mints may be engaged in a fierce competition over the public money. Each mint will use it's own privacy coin procedure to lure the public in its direction. The profits from selling “privacy” are quite attractive, their cost is minimal, so one may expect imaginative competitions between mints and their associated banks.

### Fixed Privacy Surcharge Unlimited Amount

The mint will determine a surcharge, s, above the nominal price, n. (s>n). Anyone desiring privacy will be able to purchase the privacy coins and use them for private transactions.

A variation thereto will be to set up some t categories of privacy coins pc₁, pc₂, . . . pcₜ, costing of t different surcharges: s₁, s₂, . . . sₜ respectively where sᵢ₊₁>sᵢ for i=1, 2, . . . (t−1). and where these categories are each associated with maximum purchase price. pₘₐₓ₁, pₘₐₓ₂, . . . pₘₐₓₜ, where pₘₐₓ₍ᵢ₊₁₎>pₘₐₓᵢ for i=1, 2, . . . (t−1). The higher the maximum purchase price limit the higher the price of the coin.

The amount of privacy coin purchased will serve as an objective indicator for how important privacy is for the trading public. The mint will pocket the surcharge as net profit because the redemption value of the privacy coin is their nominal value. To wit. A merchant offers goods for sale at a price of $x. A buyer wishes to buy these goods while maintaining their identity private. The buyer will then buy privacy coin at a nominal value of $x but pay the surcharge price $y>$x. The buyer will then pass the privacy coins to the merchant and so receive the goods without disclosing his identity. The merchant nominally will pass the privacy coins to the mint for redemption. The mint will pay the merchant $x—the price set by him for the goods and the surcharge $(y−x) will be pocketed by the mint.

In practice the merchant will likely not redeem the privacy coins but keep them for his privacy concerns. Overall privacy coins will circulate endlessly because they have an advantage over nominal coins. The mint may allow for fair exchange of one privacy coin with another.

The mint can boost its profits by imposing an expiry date for the privacy coins. Holders will be anxious to redeem these coins before they lose value. If these holders need more privacy in their purchase they will have to buy new privacy coins and pay again to the mint.

### Supply Management Strategy

In the previous strategy the mint was setting a price for which to sell privacy (coin surcharge) and then mint exactly the amount demanded by the market. The more privacy coins in circulation, the greater the profits for the mint. An alternative strategy is one where the mint set a first surcharge s₁ and a first amount of money, m₁ of coins to be minted. Once the public purchased all the coins covering the limited amount m₁, no more coins are minted.

In the case where the demand for privacy coins is growing, the m₁ privacy coins become a market commodity. Private exchanges will be formed where “sell” offer price and “buy” offer price will be negotiated to a transactional price, t₁. If demand for privacy wanes then t₁<s₁. And in case of an expiry date then when time comes close to expiry we would expect t₁→n, where n is the nominal price of the coin.

If, on the other hand, the demand for privacy looms then the exchange price for the privacy coin will surcharge above the original sale price: t₁>s₁.

The mint following the price dynamics for its privacy coin will want to pitch in. As things are, without the mint coming in, the members of the public who sell private coins to those who desire them will be the ones who pocket the profit of the high price. The mint will set a max value t′₁, at which point the mint will offer to the public a new batch of privacy coin in the amount m₂, and at a surcharge rate s₂=t′₁—the price of the privacy coin as set by the market, or a little less than t′₁. The fresh supply of m₂ coins will keep the price from rising until such time, should it arrive, when m₂ is sold out. And then the price of privacy coin t₂ in the free market may swing to less than s₂, or to more than s₂. This move of flooding the market with m₂ new coins will net the mint a profit of m₂*s₂, which otherwise would have been earned by members of the public holding these coins.

This offer of extra m₂ privacy coins will top the price of the coin at s₂, for as long as there is a stock of m₂ to sell. Once this stock is exhausted, the price of the privacy coins on the market t₂ will be either lower than s₂ if the demands wanes, or higher, if the demand increases.

If the demand increases then a third round is possible: new m₃ worth of privacy coins quantity at a price of s₃, will be offered by the mint, and so on as many steps as warranted.

The mint has many variables to optimize here: how many new privacy coins to offer at what price, etc. Mints will compete on service to the trader while increasing their profits.

Privacy v. Non-Privacy Procedures

We consider the following trade modes:
1. BitMint basic
2. BitMint tracked basic
3. BitMint*LeVeL private
4. BitMint*LeVeL tracked

The most basic BitMint trade is the ‘basic’ mode. A trader buys a BitMint coin, passes it on to a second trader (in full or in part), the second passes it to a third trader, and so on until the final trader submits it for redemption. The mint redeems its coin for their nominal value but charges a small fee for purchase and a small fee for the redemption. In practice any payee, being mistrustful of the payor, will not acknowledge the payment until the paid BitMint coin is stamped as “redemption ready” by the mint. The payee may redeem or plan to use further that coin. In a normal environment traders are mutually apprehensive so each payee will check with the mint to ensure the coin is bona fide. However there are several occasions where a “traders' trust zone” exists, namely, a set of partners comprised of traders that trust each other to be honest. In such a traders' trust zone a coin or its part will be moving from one trader to another without anyone except the traders themselves knowing about it. Eventually the final trader will redeem it (T_{f}) but the previous trades remains secret: from the coin trader who bought the coin from the mint, to the redeemer. The traders in the trust zone maintain their privacy from outside observers.

In the BitMint tracked mode, the mint keeps a copy of the money in the trader's device. Each payment is recorded both on the device and in the mint. The only way that money can pass in this mode is from one registered account to another. The tracking may also log the cause money has been transferred. (what was bought with that money). In this mode the identity of the money is written once in the owner's device and once in the mint's records. The advantage over classical account payment is that both on the payor's device and on the mint or bank records the money is written in the BitMint way, namely it is written as a string of financial bits for which the bit identity represents the coin identity not the coin value.

In the private LeVeL trade the payee adjusts the public record to reflect the fact that they are the new owner of the identified coin. The mint allows the new owner to make the adjustment and present himself as the new owner and that without identifying the identity of the new owner. In the tracked mode the mint will not allow the payee to adjust the public record of the status of the outstanding coins unless the payee identified himself properly before the mint. What exactly passes as “properly” may be different from mint to mint.

### Mint Transactions Limitations

### Categories

1. Transaction Fee Reduction/Elimination
2. Security Issues

### Transaction Fee Reduction/Elimination

Operating the mint is costly, the beneficiaries should pay. Nominal pay is in the form of purchase fee, p and redemption fee, r.

An alternative way will be to reduce the unlimited trade option built into the basic LeVeL (application Ser. No. 17/537,381) as in the continued patent, and monetize the levied limitations.

In a basic nominal LeVeL, (application Ser. No. 17/537,381) a trader can purchase any amount of BitMint*LeVeL digital money, however small, redeem such money any time, however close to the moment of purchase, and redeem any desired amount however small. Such unlimited trade regimen requires the mint to keep all the cash and funds it gets for its digital money in a 100% ready state, and to expend processing energy and cost to handle very small very frequent transactions.

We now consider the following limitations:
1. minimum purchase amount. pₘᵢₙ
2. minimum redemption amount rₘᵢₙ
3. minimum time interval between purchase and redemption, tₘᵢₙ

Together these limitations will dampen the trade dynamics, there will be fewer purchase-redemption transactions, and as a result the average deposit time when funds used to purchase BitMint*LeVeL money will increase, and so will increase the interest profit from deposing these funds in ready to use instrument that still bears interest. Any combination of purchase fee, p and redemption fee r may be matched with several combinations of pₘᵢₙ, rₘᵢₙ, and tₘᵢₙ.

$$[ p , r ] \to [ {p}_{m i n} , {r}_{m i n} , {t}_{m i n} ]$$

### Security Concerns for Mint Transactions Limitations

### Types:

1. Undisclosed Authentication
2. Time Delay
3. Physical Authentication

A special LeVeL parameter will indicate that this coin is associated with a special release tag that must be submitted by the current owner. The current owner wishing to pass the money to a payee, will request the mint to activate the time period for the current owner to pass to the mint to the special release tag. That tag may be a warning tag, I am being coerced into this transaction, OK it but chase and catch the payee. Time delay may be minutes, days or longer, May be associated with undisclosed authentication. The current owner may require that the payee identify himself before a national official, like a post office clerk before the mint will change the coin status to the payee. The identity of the payee may not be known to the payor nor to the mint. They know that a government official verifies the identity of the recipient. This may happen when the payee presents his LeVeL credentials to the mint. The mint gives the presenter a secret key which the presenter presents to the identify verifier.

What is claimed is:

1. A method employing computer networks,
comprising a server and personal computing devices, to exercise public communication and coordination game while supporting educational aims, and providing social entertainment; implementable as a charitable contribution, and as a for-profit competition; easy for public participation, effective for small groups, medium groups, and very large groups; with full spread over cyberspace, the method is called “2Last”;
the essential participants of 2Last are:
(i) one game master, running a computer server, and offering participation applications for the public to download to their personal computing devices; the game master determines the rules of the game, and operates it;
(ii) arbitrary count, n players, competing in the game, the players engage through the game applications operating from their personal computing devices;
the essential elements of the 2Last method are
(i) network communicated digital coins designated as “life coins”,
(ii) a “life bank”, a digital repository of “life coins, maintained in the server;”
(iii) “binary questions”—questions that limit the possible answers to two,
(iv) “play rounds”, successive repetition of procedures, where a procedure is a sequence of steps where the game master presents an arbitrary binary question on their server, the question is communicated to the private computing devices of the players, and the players answer the binary question by clicking on their personal computing devices and thereby the answers of the players are communicated to the server to be tallied;
(v) “a randomized players eliminator” (shark), which is activated by the server in their server to generate a randomized choice;
the essential operation of the 2Last method is:
(a) initial settings,
(b) a sequence of play rounds,
(c) declaration of winners and distribution of a winning prize;
the 2Last computerized process is comprising a sequence of play rounds, where rounds leads to a transaction of life coins between the players and the life-bank, and to a chance occurrence of elimination of players who own the least number of life coins; the players who survived the highest number of rounds are declared winners, and share a designated prize;
the transactions of life-coins at the end of each round is determined as follows:
an arbitrary binary question, is presented to the players by the game master; the players each answer the binary question without knowledge of how the other players answer it; they do so by clicking on their personal computing device, the answer is communicated to the server, when all participating players have answered the binary question, the game master reveals all the answers to all the players by posting them on a website; if all players answer (vote) the same way, or if the count of players who vote one way is the same as the count of voters who vote the other way, then no transaction occurs;
otherwise, the majority voters pay life-coins to a “round fund”, for which the life bank will contribute a certain count of non-negative life coins, and the round fund is distributed equally in units of life coins among the minority voters, these transactions are carried out on the server who communicates the results to the personal computing devices held by the players;
each round is concluded with a randomized invocation of the shark, a process that eliminates from the competition all the players who cannot point to another player who has fewer life coins than they have; the next round proceeds with the players that survived the shark attack;
the initial setting comprises:
(a.i) determination of rules, by the game master: how many life-coins, s, are given to each player by the life-bank, creating a game-starting life-coins account for each player; what are the binary questions, the specific protocol for the life-coins transaction per each round, the probability for the shark to be activated after each round, the timings for the round, when it starts when it ends;
the players are being allocated s life coins each, before the rounds begin, the life bank has unlimited number of life coins.

2. The method in claim 1 where the m majority voters after each round are paying one life coin each to a “round fund”, R, so that |R|=m; if t=m/f is an integer where f is the number of minority voters for the same round, then each minority voter receives t life-coins to their life coin account; and if t is not an integer than the life-bank is adding one life-coin at a time to the round fund R, such that after adding b bank life coins the division t′=|R|/f=(m+b)/f computes to an integer and then t′ life coins are being allocated to each of the minority voters life coins account.

3. The method of claim 1 where the player elimination probability is changing from round to round by a rule preset by the game master.

4. The method of claim 1 where the binary question repeats itself as a choice between two options designated “green” and “blue”.

5. The method of claim 1 where the binary questions are statements expressing knowledge from a declared field of knowledge, or expressing a fallacy from the same declared field of knowledge, and the binary questions are limited to true/false; the life-coins transactions after each round are based on the count of “true” answers versus the count of “false” answers, not on whether the true or false answers are correct or not.

6. The method of claim 1 where players pay play fee, p each, creating a distribution fund F, where |F|=np; a pre-determined portion H is given to a declared public cause and the balance np(1−H) is divided equally among the winners: the ones with the highest life span, where life-span of a player is measured by the count of the round in which the player was eliminated from the game.

7. The method of claim 1 where the n players are organized in g groups of d players each, n=gd, and where individual players compete individually, trying to stay alive for as many rounds as possible, also the g groups are competing against each other, where each group tries to get the highest count of the summary of the life-spans of its members.

8. The method in claim 7 where the players pay a play fee, p, for individual competition, and the fund F=np is distributed to the winner as pre agreed; and the players also pay a group fee, p*, to a fund F*=np* which is distributed to the winning groups as pre agreed; and where groups can be assembled into super-groups that will compete with each other per the sum of the life spans of groups.

9. A method to sell payment privacy to the public, balanced between
(9.a) a legitimate law-abiding demand for transactional privacy, and
(9.b) the societal need to deny criminals stealth-use of money,
the method involves a digital money mint, (“Mint”) issuing digital coins in a privacy-providing-protocol (“P3”);
P3 generates digital claim checks (“DCC”) sold to the public and redeemed from the public;
each DCC has a nominal value X, and a purchase price Y>X; the Mint sells DCC to the public at price Y and redeems it from the public at price X;
the purchaser of a DCC is the first trader, they use the DCC to honor a bill and pay the DCC to a second trader, who pays the DCC to a third trader, and so on until the last trader who redeems the DCC at the Mint;
the transactions from the first trader, to the second trader and on to the last trader are conducted through a privacy preserving algorithm, “PPA”, operated in “full mode” where payor and payee remain strangers to each other, and neither the Mint nor any authority is aware of the identities of the traders from the second trader through all the traders up to the trader before the last one;
the PPA will also operate in a “void mode” where Y=X, and where no privacy is preserved;
a holder of a DCC will use it to pay an amount X, to a payee, who in turn will redeem the DCC with the Mint for the sum X, or will use the DCC to make payment without revealing their identity;
operating PPA in full mode next to operating it with void mode will amount to offering the public the option to achieve payment privacy at a cost;
applicable regulations will determine
(i) the amount of money tradable in full mode,
(ii) the categories of merchandise that can be paid for in full mode,
(iii) preset expiry terms for the DCC, terms for redemption, beyond which the DCC will not be honored by the Mint,
(iv) the maximum size of a transaction that can be paid for in full mode;
the public demand for privacy will determine the purchase price Y of a DCC with a nominal value X.

10. The method in claim 9 wherein a DCC of nominal value X with a purchase price Y is split to two parts X′ and X″, where X=X′+X″.

11. The method in claim 9 where the Mint offers at time point tᵢ a Release-i of mᵢ DCC of nominal value x₁ and sale price yᵢ, each which are used to buy merchandise not to exceed a value pᵢ, and of expiration date rᵢ;
once the m; DCC are sold out by the Mint, they can be traded by the public at values determined by supply and demand;
for i=1, 2, . . .
where the Releases are offered in succession.

12. The method in claim 9 where n Mints are competing and each Mint-j is offering a series of P3 Releases: Rⱼᵢ, for j=1, 2, . . . n and i=1, 2, . . . competing with each other.

13. The method in claim 9 applied in conjunction with a computer network public game where the public buys admission tickets at cost A per ticket, where t winning prizes w₁, w₂, . . . wₜ are winnable at respective chances c₁, c₂, . . . cₜ, and a sum S taken from the totality of the admission tickets is dedicated to a morally abiding social cause,
where members of the public can pay for admission tickets with DCC of a P3, and be paid any winning prize they earn also as a DCC of a P3 in full mode;
thereby protecting prize winners from the common harassment which winners of lotteries are subjected to.

14. The method in claim 13 where the public game is 2Last (claims 1-8).
